(19) United States
(12) Patent Application Publication
(10) Pub. No.: US 2022/0198956 A1
(43) Pub. Date: Jun. 23, 2022

(54) MOTION TRAINING APPARATUS

(71) Applicants: Yosuke SAJIKI, Minamikoma-gun (JP); Shoichi KOYA, Minamikoma-gun (JP)

(72) Inventors: Yosuke SAJIKI, Minamikoma-gun (JP); Shoichi KOYA, Minamikoma-gun (JP)

(73) Assignee: CANON FINETECH NISCA INC., Misato-shi (JP)

(21) Appl. No.: 17/535,754

(22) Filed: Nov. 26, 2021

(30) Foreign Application Priority Data
Nov. 25, 2020 (JP) 2020-195006

(51) Int. Cl. G09B 19/00

(52) U.S. Cl. CPC G09B 19/003

(57) ABSTRACT

A motion training apparatus compact in a height direction is provided. The motion training apparatus includes an operation unit movable in an XY plane, a first actuator mechanism AX which moves the operation unit in an X-axis direction, and a second actuator mechanism AY which moves the first actuator mechanism AX in a Y-axis direction. A first belt included in the first actuator mechanism AX, a first guide rod, a second belt included in the second actuator mechanism AY, a second guide rod, a third belt, and a third guide rod are arranged between a fourth belt and a fifth belt as overlapping in a height direction.

### TECHNICAL FIELD

The present invention relates to a motion training apparatus, and more particularly, to a motion training apparatus capable of supporting planar motion of a user.

### BACKGROUND ART

Conventionally, various kinds of motion training have been carried out in order to improve a motor function. For example, wiping training in which shoulders and elbows are bent and extended by motion such as wiping a desk, and sanding training in which hands are slid up and down on an inclined board are widely performed. Various motion training apparatuses have been proposed to support such motion training.

For example, Patent Document 1 discloses a motion training apparatus including an operation unit which is movable in an XY plane, an actuator mechanism including X-axis and Y-axis drive direction motors and capable of driving the operation unit in the XY plane, a force sensor which detects forces Fx, Fy acting on the operation unit in the X-axis and Y-axis directions, and a controller which controls the X-axis and Y-axis drive direction motors based on the forces Fx, Fy in the X-axis and Y-axis directions detected by the force sensor. In this motion training apparatus, the operation unit is arranged on a first linear motion guide member, the first linear motion guide member is arranged on the second linear motion guide member so as to be perpendicular to a second linear motion guide member, the first linear motion guide member is moved in the Y-axis direction on the second linear motion guide member, and further, the operation unit is moved in the X-axis direction on the first linear motion guide member, whereby the operation unit is movable in the XY plane.

### PRIOR ART DOCUMENT

### Patent Document

Patent Document 1: Japanese Patent Application Laid-Open No. 2020-89621

### DISCLOSURE OF INVENTION

### Problems to be Solved by the Invention

Strengthening of muscles of limbs and improvement of the movable range of joints can be effectively performed by widely securing the movable range of the operation unit when performing motion training of the limbs. However, in the configuration of Patent Document 1, when a wide movable range of the operation unit is secured, high strength of a support member supporting the operation unit is required, and an increase in the thickness of the apparatus (size in a direction perpendicular to the XY plane) cannot be avoided.

### Means for Solving the Problem

The present invention provides a motion training apparatus for moving an operation unit in an XY plane by a drive motor based on information input to a force sensor due to operation of a user to the operation unit including the force sensor. The motion training apparatus includes a base parallel to the XY plane, a first holding member holding the operation unit on the base, a first belt routed to two pulleys arranged in an X-axis direction of the XY plane and configured to move the first holding member in the X-axis direction, a first guide member configured to movably guide the first holding member in the X-axis direction, a second holding member holding one end of the first guide member and one of the pulleys, a second belt configured to move the second holding member in a Y-axis direction perpendicular to the X-axis direction, a second guide member configured to movably guide the second holding member in the Y-axis direction, a third holding member holding the other end of the first guide member and the other of the pulleys, a third belt configured to move the third holding member in the Y-axis direction in synchronization with the second holding member, a third guide member configured to movably guide the third holding member in the Y-axis direction, a first drive motor arranged at the second holding member and configured to drive the first belt, a second drive motor configured to drive the second belt and the third belt, a fourth belt configured to transmit driving of the second drive motor to the second belt, and a fifth belt configured to transmit driving of the second drive motor to the third belt. Here, the first belt, the first guide member, the second belt, the second guide member, the third belt, and the third guide member are arranged between the fourth belt and the fifth belt as overlapping in a height direction from the base being a direction perpendicular to the XY plane.

### Advantageous Effect of the Invention

According to the present invention, it is possible to provide a motion training apparatus which is compact in a height direction being perpendicular to a base.

### BRIEF DESCRIPTION OF DRAWINGS

FIG. 1 is an external perspective view of a motion training apparatus according to an embodiment to which the present invention is applicable.

FIG. 2 is a perspective view of an apparatus main body of the motion training apparatus of the embodiment.

FIG. 3 is a sectional view showing details of a first actuator mechanism.

FIG. 4 is a sectional view showing details of a second actuator mechanism.

FIG. 5 is a perspective view showing the configuration of an operation unit.

FIG. 6 is a block diagram of a controller of the motion training apparatus.

### MODE FOR CARRYING OUT THE INVENTION

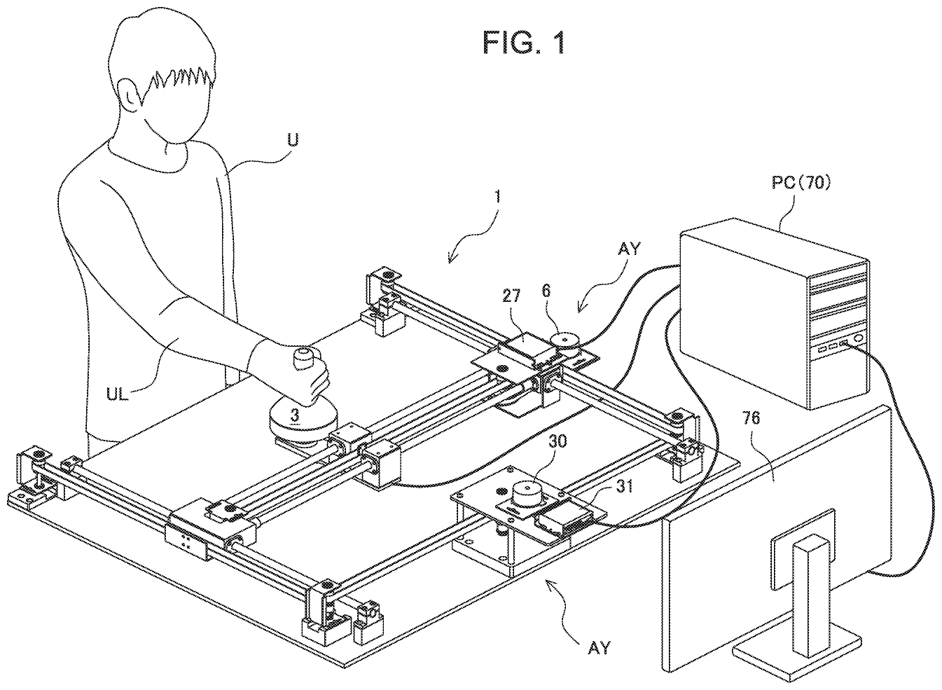

In the following, embodiments of a motion training apparatus applicable to the present invention will be described with reference to the drawings. The motion training apparatus of the embodiment is placed on a substantially horizontal placement surface, and is used for, for example, motion training to be performed for the purpose of improving the motor function of the upper limb of a user (motion trainee) (see FIG. 1). As shown in FIG. 1, a motion training apparatus 1 includes an operation unit 3, and a user U is positioned in front of the motion training apparatus 1 and extends the right arm UL forward to grasp the operation unit 3 with the right hand HR in order to perform, for example, upper limb motion training. In the present specification, the near side and the far side of the motion training apparatus 1 from the user U in FIG. 1 are referred to as the front side and the rear side, respectively.

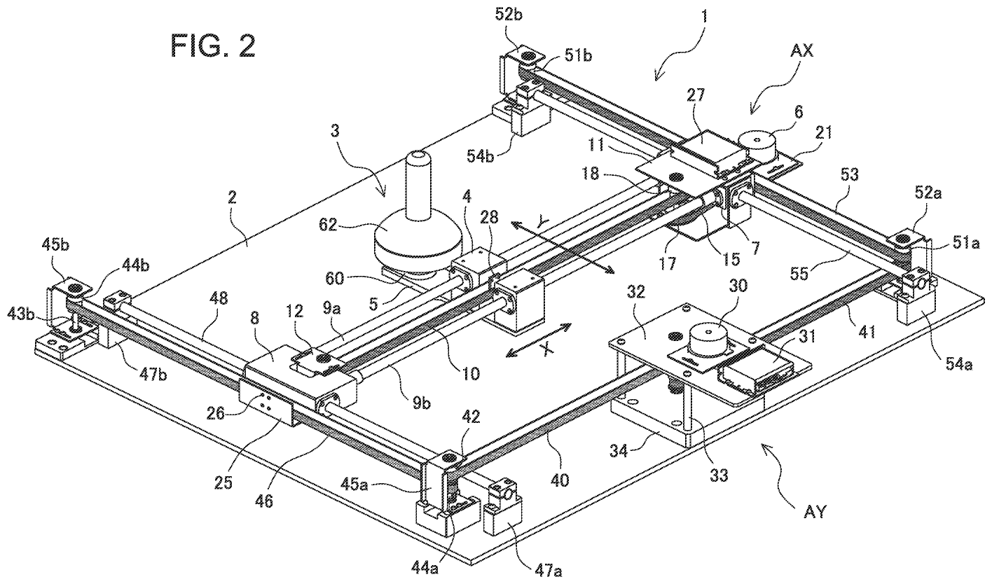

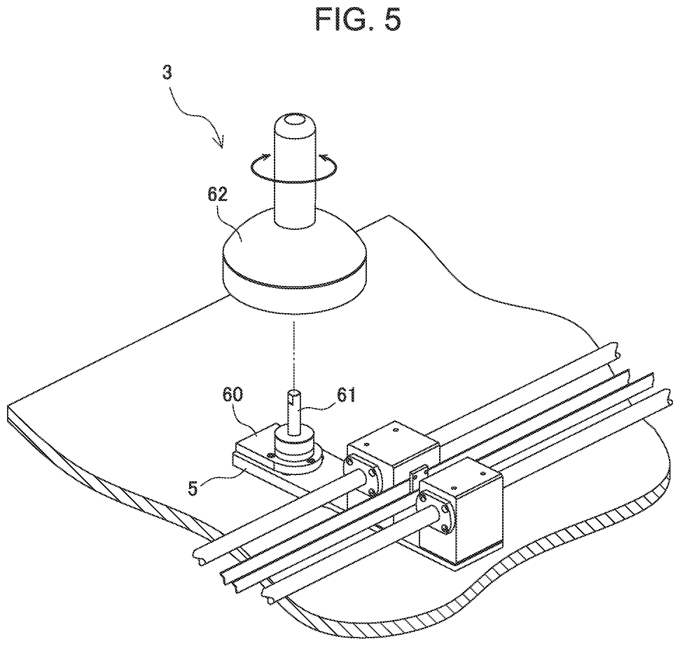

The motion training apparatus 1 includes the operation unit 3 which is movable in the XY plane (a horizontal plane parallel to the placement surface and a base 2), a first actuator mechanism AX which moves the operation unit 3 in the X-axis direction (the direction of arrow X in FIG. 2), and a second actuator mechanism AY which moves the operation unit 3 and the first actuator mechanism AX in the Y-axis direction (the direction of arrow Y in FIG. 2). The operation unit 3 includes a force sensor 60 (see FIG. 5) which detects forces acting on a handle member 62 in the X-axis and Y-axis directions. Further, the motion training apparatus 1 includes a computer PC (controller 70) and a monitor 76. The computer PC is connected to the force sensor 60, motor control units 27, 31, and the monitor 76. X-axis and Y-axis direction drive motors 6, 30 are integrally configured with encoders (not shown) for detecting the position of the operation unit 3 in the XY plane, respectively.

With such configurations, the computer PC and the motor control units 27, 31 control driving of the X-axis and Y-axis direction drive motors 6, 30 based on input values from the force sensor 60 and the encoders, cause the operation unit 3 to move in the XY plane, and cause training information, movement trajectory of the operation unit 3, or the like to be displayed on the monitor 76.

Hereinafter, each configuration will be described in detail based on FIGS. 2 to 5. The operation unit 3 is attached to a first slider block 4 (first holding member) via an attachment plate 5, and is configured to move integrally with the first slider block 4. The first slider block 4 is slidably arranged along first guide rods 9a, 9b extending in the X-axis direction in the XY plane. A part of a first belt 10 is fixed to the first slider block 4 by a belt fixing plate 28 and screws 29. Thus, when the first belt 10 is rotationally driven by a first dive motor (X-axis direction drive motor) 6, the first slider block 4 slides in the X-axis direction along the first guide rods 9a, 9b.

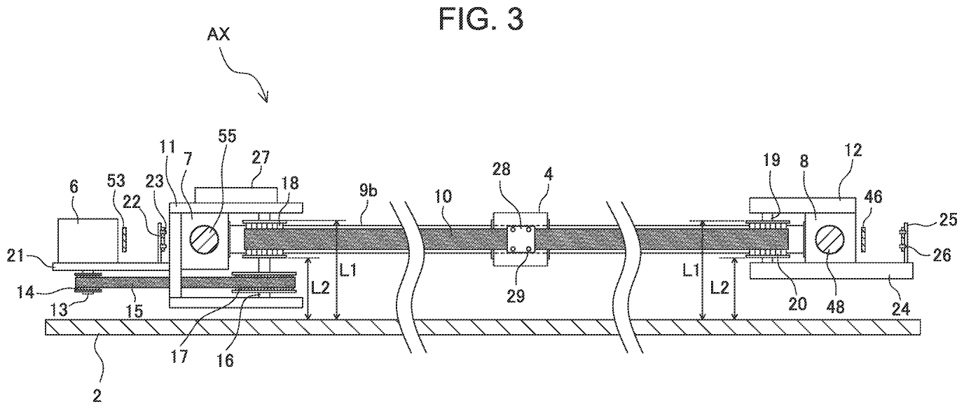

As shown in FIG. 3, driving of the first drive motor 6 of the first actuator mechanism AX is transmitted to a pulley 18 via a shaft 13, a pulley 14, a belt 15, a pulley 17, and a shaft 16. The first drive motor 6 is arranged on a support plate 21, and the support plate 21 is fixed to a support plate 11. The support plate 11 rotatably supports the shaft 16, and fixedly supports a second slider block 7 and the motor control unit 27. Here, the support plate 11 and the second slider block 7 are collectively referred to as a second holding member which holds one end of each first guide rod 9a, 9b and the pulley 18. Support plates 12, 24 are arranged on the side opposite to the first drive motor 6 in the X-axis direction. The support plates 12, 24 rotatably support a shaft 19 and fixedly support a third slider block 8. A pulley 20 is arranged on the shaft 19, and the first belt 10 is routed between the pulley 18 and the pulley 20. One end of each first guide rod 9a, 9b is fixedly supported by the second slider block 7 and the other end of each first guide rod 9a, 9b is fixedly supported by the third slider block 8. Here, the support plates 12, 24 and the third slider block 8 are collectively referred to as a third holding member which holds the other end of each first guide rod 9a, 9b and the pulley 20.

As described above, a part of the first belt 10 is fixed to the first slider block 4, and when the first drive motor 6 is driven, the pulley 18 rotates so that the first belt 10 rotates together with the pulley 20, whereby the first slider block 4 slides in the X-axis direction along the first guide rods 9a, 9b. The first belt 10 and the first guide rods 9a, 9b are parallel to the X-axis direction, the first guide rods 9a, 9b are arranged on both sides of the first belt 10, and the height positions thereof from the base 2 are substantially the same.

The second slider block 7 and the third slider block 8 included in the first actuator mechanism AX are supported to be slidable in the Y-axis direction with respect to a third guide rod 48 and a second guide rod 55, and the entire first actuator mechanism AX is movable in the Y-axis direction with rotation of a third belt 46 and a second belt 53. As shown in FIG. 3, a part of the second belt 53 is fixed by screws 23 to a belt fixing plate arranged on the support plate 21 fixed to the second slider block 7. Further, a part of the third belt 46 is fixed by screws 26 to a belt fixing plate 25 arranged on a support plate 24 fixed to the third slider block 8. When a second motor (the Y-axis direction drive motor) 30 of the second actuator mechanism AY is driven to rotate, the third belt 46 and the second belt 53 rotate, whereby the first actuator mechanism AX slides in the Y-axis direction.

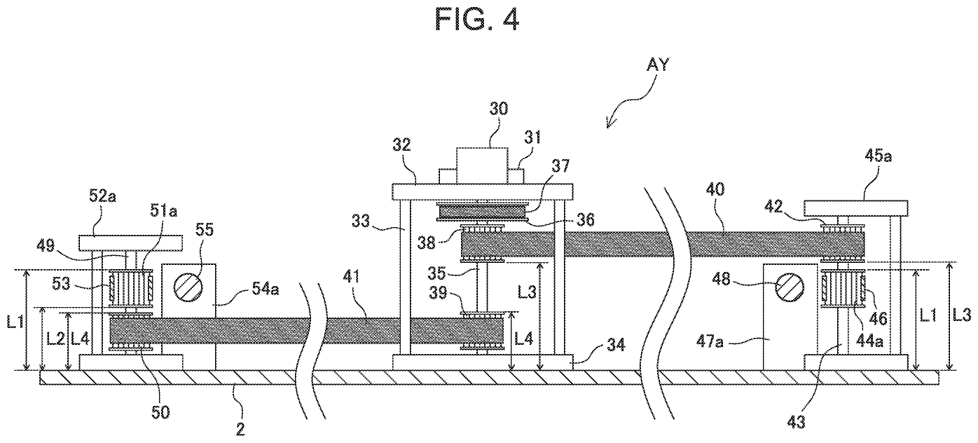

Next, the second actuator mechanism AY will be described with reference to FIGS. 2 and 4. The second actuator mechanism AY is a mechanism for moving the first actuator mechanism AX in the Y-axis direction. The second motor 30 and the motor control unit 31 are arranged above a support frame configured of a support plate 34 arranged on the base 2, a support column 33, and a support plate 32. The support frame is fixed to the center part on the apparatus far side being opposite to the user (monitor 76 side of the base 2).

The second motor 30 is provided with a shaft and a pulley (not shown). A belt 37 is routed between the pulley (not shown) and a pulley 36. A shaft 35 is rotatably supported between the support plates 32, 34, pulleys 37, 38, 39 are arranged on the shaft 35, and the rotational force of the pulley 36 is transmitted to the pulleys 38, 39 through the shaft 35.

Support plates 45a, 52a each formed in a U-shape are arranged on both sides of the support frame in the X-axis direction, respectively. The support plate 45a rotatably supports a shaft 43, and pulleys 42, 44a are arranged on the shaft 43. A belt 40 is routed between the pulley 38 and the pulley 42, and the rotation driving of the second motor 30 is transmitted to the pulley 44a through the belt 37, the pulley 36, the shaft 35, the pulley 38, the belt 40, the pulley 42, and the shaft 43 (i.e., the belt 40 is a fifth belt for transmitting the driving of the second motor 30 to the third belt 46).

A guide support portion 47a is arranged in the vicinity of the support plate 45a and supports one end of the third guide rod 48. Further, a support plate 45b serving as a pair with the support plate 45a and a guide support portion 47b serving as a pair with the guide support portion 47a are arranged on the base 2 on the side (apparatus right near side) opposite to the support plate 45a in the Y-axis direction.

The support plate 45b rotatably supports a shaft 43b, and a pulley 44b serving as a pair with the pulley 44a is arranged on the shaft 43b. The third belt 46 is routed between the pulleys 44a, 44b, and a part thereof is fixed to the belt fixing plate 25 which moves integrally with the third slider block 8 as described above. Further, the guide support portion 47b supports the other end of the third guide rod 48, and fixedly supports the third guide rod 48 together with the guide support portion 47a. The third belt 46 and the third guide rod 48 extend in parallel to the Y-axis direction, and the height positions thereof from the base 2 are substantially the same.

The support plate 52a is arranged on the side (left far side of the base 2) opposite to the support plate 45a in the X-axis direction with respect to the support frame. The support plate 52a rotatably supports a shaft 49, and pulleys 50, 51a are arranged on the shaft 49. A belt 41 is routed between the pulley 39 and the pulley 50, and the rotation driving of the second motor 30 is transmitted to the pulley 51a through the belt 37, the pulley 36, the shaft 35, the pulley 39, the belt 41, the pulley 50, and the shaft 49 (i.e., the belt 41 is a fourth belt for transmitting the driving of the second motor 30 to the belt 41).

A guide support portion 54a is arranged in the vicinity of the support plate 52a and supports one end of the second guide rod 55. Further, a support plate 52b serving as a pair with the support plate 52a and a guide support portion 54b serving as a pair with the guide support portion 54a are arranged on the base 2 on the side (apparatus left near side) opposite to the support plate 52a in the Y-axis direction.

The support plate 52b rotatably supports a shaft 49b, and a pulley 51b serving as a pair with the pulley 51a is arranged on the shaft 49b. The second belt 53 is routed between the pulleys 51a, 51b, and a part thereof is fixed to a belt fixing plate 22 which moves integrally with the second slider block 7 as described above. Further, a guide support portion 54b supports the other end of the second guide rod 55, and fixedly supports the second guide rod 55 together with the guide support portion 54a. The third belt 46 and the third guide rod 48 extend in parallel to the Y-axis direction, and the height positions thereof from the base 2 are substantially the same.

As described above, the rotation driving of the second motor 30 is transmitted to the pulley 44a and the pulley 51a, and thus the third belt 46 and the second belt 53 rotate. Accordingly, the third slider block 8 and the second slider block 7 (i.e., the entire first actuator mechanism AX) fixed to the third belt 46 and the second belt 53 slide in the Y-axis direction along the third guide rod 48 and the second guide rod 55, respectively.

Here, referring to FIG. 4, the belt 40 and the belt 41 extend in parallel to the X-axis direction, but differ from each other in the height direction (the distance from the base 2). Specifically, the belt 41 is arranged below the belt 40. Then, in the height direction, the third belt 46, the third guide rod 48, the second belt 53, and the second guide rod 55 are arranged at substantially the same height between the belt 40 and the belt 41.

Further, referring to FIGS. 2 and 3, between the third guide rod 48 and the second guide rod 55 for moving the operation unit 3 and the first actuator mechanism AX in the Y-axis direction, the first guide rods 9a, 9b and the first belt 10 for moving the operation unit 3 in the X-axis direction extend in the X-axis direction perpendicular to the third guide rod 48, the third belt 46, the second guide rod 55, and the second belt 53 arranged in parallel to the Y-axis direction. Then, the first belt 10, the first guide rods 9a, 9b, the third belt 46, the third guide rod 48, the second belt 53, and the second guide rod 55 are arranged between the belt 40 and the belt 41 in the height direction. Thus, the motion training apparatus can be configured to be thin in the height direction as compared with a conventional motion training apparatus.

In other words, in FIG. 4, when the distance from the base 2 to the upper end of the pulleys 44a, 51a (in the direction perpendicular to the XY plane, that is, height) is L1, the distance from the base 2 to the lower end of the pulleys 44a, 51a is L2, the distance from the base 2 to the lower end of the pulleys 38, 42 is L3, and the distance from the base 2 to the pulleys 39, 50 is L4, each member is arranged so as to satisfy the following relationship.

“L1>L2”, “L3>L1”, and “L2>L4”.

Therefore, “L3>L1>L2>L4” is satisfied, and the pulley 44a and the pulley 51a are arranged between positions corresponding to L3 and L4. Each of the belts are bridged between the upper end and the lower end of the corresponding pulleys. The center of the third belt 46 and the second belt 53 and the center of the third guide rod 48 and the second guide rod 55 are substantially the same in the height direction. The members are arranged so that the upper end of the third guide rod 48 does not interfere with the belt 40 and the lower end of the second guide rod 55 does not interfere with the belt 41.

In FIG. 3, the distance from the base 2 to the upper end of the pulleys 18, 19 is L1, and the distance from the base 2 to the lower end of the pulleys 18, 19 is L2. Thus, the first belt 10, the first guide rods 9a, 9b, the third belt 46, the third guide rod 48, the second belt 53, and the second guide rod 55 are arranged so as to overlap in the height direction between the height positions corresponding to L3 and L4, that is, between the lower end of the pulleys 38, 42 and the upper end of the pulleys 39, 50.

The first belt 10 is arranged so as to be sandwiched between the first guide rods 9a, 9b. Therefore, the first belt 10 can receive a rotation force about the first guide rod 9a or 9b when the user applies a force to the operation unit 3, and movement in the rotation direction can be suppressed.

The operation unit 3 is arranged in the near side with respect to the first slider block 4 as shown in FIG. 1 and is configured of a relatively short vertical operation rod 61 and the handle member 62 arranged at the upper end thereof as shown in FIG. 5. The handle member 62 of the present embodiment is formed in a relatively thick and small disk shape so that the user U can grasp with one hand in order to train the motor function of the upper limb UL. The handle member 62 is attached to be rotatable about the operation rod 61 so that the user can grasp and rotate the handle member 62 with his/her hand.

Further, the operation unit 3 includes the force sensor 60 arranged integrally with the operation rod 61. The force sensor 60 is integrally fixed to the first slider block 4 of the first actuator mechanism AX via the attachment plate 5. The force sensor 60 detects a force of the user acting on the operation rod 61 from the handle member 62 in both an active operation in which the user moves the operation unit 3 by his/her own force and a passive operation in which the upper limb or the lower limb is moved by a force of the operation unit 3. In the present embodiment, a six-axis force sensor using strain gauges is adopted as the force sensor 60.

In general, a six axis force sensor can detect forces (Fx, Fy, Fz) in three orthogonal axial directions of x, y, z and moments (Mx, My, Mz) around the three axes of x, y, z. In the present embodiment, the X-axis and the Y-axis of the six-axis force sensor are arranged so as to coincide with the left-right direction (the direction parallel to the first guide rods 9a, 9b) and the front-rear direction (the direction parallel to the third guide rod 48 and the third guide rod 53) of the first actuator mechanism AX, respectively.

Thus, when the upper limb or the lower limb of the user moves the operation unit 3 or is moved by the operation unit 3, the force sensor 60 can divide the force directly received by the operation rod 61 from the upper limb or the lower limb of the user into a force component in the front-rear direction, a force component in the left-right direction, and a force component in the vertical direction orthogonal thereto, and can further detect the force as moments acting around each of the axes in the front-rear direction, the left-right direction, and the vertical direction.

In actual use of the motion training apparatus 1, force components in the front-rear direction (the Y-axis direction), the left-right direction (the X-axis direction), and the vertical direction (the height direction orthogonal to the XY plane) detected by the force sensor 60 are detected as differences between the rotational forces of the first and/or second drive motors 6, 30 and the force applied to the operation unit 3 by the user, that is, as drag that the operation unit 3 receives from the upper limb or lower limb of the user. For example, in the training of the passive operation, the force of the user is the load, that is, the rotational drag acting on the first and/or second drive motors 6, 30 as the resistance against movement of the operation unit 3. In the training of the active operation, the rotational forces of the first and/or second drive motors 6, 30 act as resistance, that is, to apply the load to the user against movement of the operation unit 3 by the force of the user.

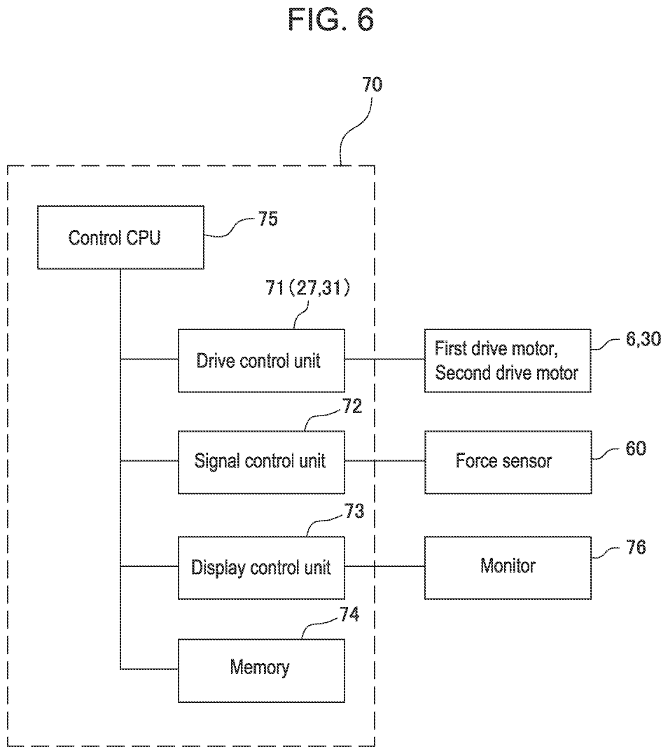

Further, the motion training apparatus 1 includes the controller 70 for controlling the first drive motor 6 and the second motor 30. As shown in FIG. 6, the controller 70 includes a drive control unit 71 (including the motor control units 27, 31, which may be incorporated into the PC of FIG. 1), a signal control unit 72, a display control unit 73, a memory 74, and a control CPU 75 for controlling and managing these units.

The drive control unit 71 is connected to the first drive motor 6 and the second motor 30 and controls the driving thereof. The signal control unit 72 is connected to the force sensor 60 and receives the signal output from the force sensor 60. The display control unit 73 is connected to the monitor 76 and controls the display of the monitor 76. The memory 74 stores, in addition to a program for operating the motion training apparatus 1, data related to training such as personal data and a training history of the user.

Detailed control of the motion training apparatus 1 is described in Japanese Patent Application Laid-Open No. 2020-89621, and therefore description thereof is omitted.

In the present embodiment, an aspect in which the operation unit 3 is arranged at a position overlapping with the first slider block 4 via the attachment plate 5 in the height direction and fixed with the lower end of the operation unit 3 not in contact with the base 2 is shown. However, a sliding member such as a freely rotating roller may be arranged at the lower surface of the attachment plate 5 so that the operation unit 3 smoothly moves on the base 2, and the lower surface of the attachment plate 5 and the base 2 may be configured to contact to each other. Thus, a downward force applied by the user can be received by the base 2.

The operation unit 3 may be attached to the upper part of the first slider block 4. Thus, the movable area of the operation unit 3 can be widened further to the apparatus far side.

This application claims the benefit of Japanese Patent Application No. 2020-195006 which is incorporated herein by reference.

1. A motion training apparatus for moving an operation unit in an XY plane by a drive motor based on information input to a force sensor due to operation of a user to the operation unit including the force sensor, comprising:
a base parallel to the XY plane;
a first holding member holding the operation unit on the base;
a first belt routed to two pulleys arranged in an X-axis direction of the XY plane and configured to move the first holding member in the X-axis direction;
a first guide member configured to movably guide the first holding member in the X-axis direction;
a second holding member holding one end of the first guide member and one of the pulleys;
a second belt configured to move the second holding member in a Y-axis direction perpendicular to the X-axis direction;
a second guide member configured to movably guide the second holding member in the Y-axis direction;
a third holding member holding the other end of the first guide member and the other of the pulleys;
a third belt configured to move the third holding member in the Y-axis direction in synchronization with the second holding member;
a third guide member configured to movably guide the third holding member in the Y-axis direction;
a first drive motor arranged at the second holding member and configured to drive the first belt;
a second drive motor configured to drive the second belt and the third belt;
a fourth belt configured to transmit driving of the second drive motor to the second belt; and
a fifth belt configured to transmit driving of the second drive motor to the third belt,
wherein the first belt, the first guide member, the second belt, the second guide member, the third belt, and the third guide member are arranged between the fourth belt and the fifth belt as overlapping in a height direction from the base being a direction perpendicular to the XY plane.

2. The motion training apparatus according to claim 1,
wherein the second drive motor is arranged substantially at a center part on the base on a side opposite to the user, and
the second belt and the second guide member are arranged on a side opposite to the third belt and the third guide member in the X-axis direction with respect to the second drive motor and extend in parallel to the Y-axis direction.

3. The motion training apparatus according to claim 1,
wherein the first guide member includes two guide rods arranged in parallel to the X-axis direction, and the first belt extends in the X-axis direction between the two guide rods.
